(19) United States
(12) Patent Application Publication
(10) Pub. No.: US 2025/0365301 A1
(43) Pub. Date: Nov. 27, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Jun KODAMA, Tokyo (JP); Yuji KOBAYASHI, Tokyo (JP); Takehiko MIZOGUCHI, Tokyo (JP); Yoshiaki SAKAE, Tokyo (JP); Yasuhiro AJIRO, Tokyo (JP)

(73) Assignee: NEC Corporation, Tokyo (JP)

(21) Appl. No.: 19/203,273

(22) Filed: May 9, 2025

(30) Foreign Application Priority Data
May 21, 2024 (JP) 2024-082831

(51) Int. Cl. H04L 9/40

(52) U.S. Cl. CPC H04L 63/1425; H04L 63/1416

(57) ABSTRACT

An information processing apparatus includes: an acquisition unit for acquiring environment information indicating an environment of communication that is monitored by a monitoring apparatus that monitors communication in a network, for detection information indicating an abnormal event detected by the monitoring apparatus; an inquiry unit for transmitting inquiry information for inquiring about a factor in the occurrence of the event included in the detection information, to a language model, and acquiring response information in response to the inquiry information, from the language model; and a display unit for displaying the detection information, the environment information, and the response information.

### CROSS REFERENCE TO RELATED APPLICATION

This application is based upon and claims the benefit of priority from Japanese patent application No. 2024-082831, filed on May 21, 2024, the disclosure of which is incorporated herein in its entirety by reference.

### TECHNICAL FIELD

The present disclosure relates to an information processing apparatus, an information processing method, and a computer-readable recording medium for assisting analysis after an anomaly has been detected.

### BACKGROUND ART

There are known technologies for collecting logs from a network and performing anomaly detection in order to minimize damages to the network caused by anomalies such as targeted attacks, unknown threats, and insider threats. However, under the current circumstances, anomaly analysis is manually conducted using collected logs after an anomaly has been detected. Therefore, anomaly analysis requires a significant amount of time.

As a related technology, PLT 1 (JP 2020-092332 A) discloses a network anomaly detection apparatus that detects anomalies in a network. The network anomaly detection apparatus of JP 2020-092332 A acquires scenario information including a scenario in which chronological order relationship between events related to a plurality of flows is set in advance, and flow statistical information aggregated from header information of packets of a network during a predetermined period, and determines whether there is an abnormality in the network based on the presence or absence of flow statistical information that matches an event of the scenario in the scenario information.

However, in the network anomaly detection apparatus of JP 2020-092332 A, flows are associated with scenarios, and the anomaly detection accuracy of a matching flow is improved, but no assistance is provided in reducing the anomaly analysis time after an anomaly has been detected in the network.

### SUMMARY

An example object of the present disclosure is to assist in reducing the time required for anomaly analysis on a network.

In order to achieve the example object described above, an information processing apparatus according to an example aspect of the present disclosure includes:
an acquisition unit for acquiring environment information indicating an environment of communication that is monitored by a monitoring apparatus that monitors communication in a network, for detection information indicating an abnormal event detected by the monitoring apparatus;
an inquiry unit for transmitting inquiry information for inquiring about a factor in the occurrence of the event included in the detection information, to a language model, and acquire response information in response to the inquiry information, from the language model; and
a display unit for displaying the detection information, the environment information, and the response information.

Also, in order to achieve the example object described above, an information processing method according to an example aspect of the present disclosure includes:
acquiring, by an information processing apparatus, environment information indicating an environment of communication that is monitored by a monitoring apparatus that monitors communication in a network, for detection information indicating an abnormal event detected by the monitoring apparatus;
transmitting, by the information processing apparatus, inquiry information for inquiring about a factor in the occurrence of the event included in the detection information, to a language model;
acquiring, by the information processing apparatus, response information in response to the inquiry information, from the language model; and
displaying, by the information processing apparatus, the detection information, the environment information, and the response information, on a display unit.

Furthermore, in order to achieve the example object described above, a computer-readable recording medium according to an example aspect includes a program recorded on the computer-readable recording medium, the program including instructions that cause the computer to carry out:
acquiring environment information indicating an environment of communication that is monitored by a monitoring apparatus that monitors communication in a network, for detection information indicating an abnormal event detected by the monitoring apparatus;
transmitting inquiry information for inquiring about a factor in the occurrence of the event included in the detection information, to a language model;
acquiring response information in response to the inquiry information, from the language model; and
displaying the detection information, the environment information, and the response information, on a display unit.

As described above, according to the present disclosure, it is possible to assist in reducing the time required for anomaly analysis on a network.

### BRIEF DESCRIPTION OF THE DRAWINGS

FIG. 1 is a diagram for describing an example of a configuration of an information processing apparatus;

FIG. 2 is a diagram for describing an example of a system that includes an information processing apparatus;

FIG. 3 is a diagram for describing an example of information processing apparatuses and a corporate network;

FIGS. 4A to 4B are a diagram for describing an example of operations of the anomaly detection model;

FIG. 5 is a diagram for describing an example of anomaly detection models;

FIG. 6 is a diagram for describing an example of environment information;

FIG. 7 is a diagram for describing an example of history information;

FIG. 8 is a diagram for describing an example of inquiry information;

FIG. 9 is a diagram for describing an example of response information;

FIG. 10 is a diagram for describing an example of operations of the information processing apparatus;

FIG. 11 is a diagram for describing a first example embodiment;

FIG. 12 is a diagram for describing a second example embodiment;

FIG. 13 is a diagram for describing an example of a modified example;

FIG. 13 is a diagram for describing an example of a modified example; and

FIG. 14 is a diagram for describing an example of a computer that realizes the information processing apparatus in the example embodiment and the modified example.

### EXAMPLE EMBODIMENT

### Example Embodiment

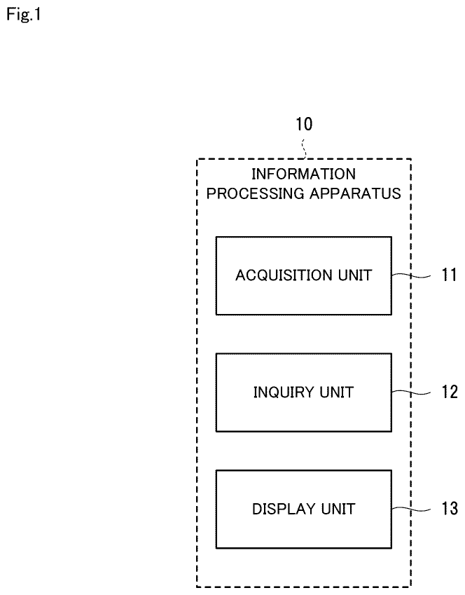

A configuration of an information processing apparatus according to an example embodiment will be described with reference to FIG. 1. FIG. 1 is a diagram for describing an example of a configuration of an information processing apparatus.

### [Apparatus Configuration]

An information processing apparatus 10 shown in FIG. 1 is an apparatus that assists in reducing the time required for anomaly analysis on a network (anomaly analysis assistance apparatus). In addition, as shown in FIG. 1, the information processing apparatus 10 includes an acquisition unit (acquisition means) 11, an inquiry unit (inquiry means) 12, and a display unit (display means) 13.

The acquisition unit 11 acquires environment information indicating the environment of communication that is monitored by a monitoring apparatus that monitors communication in a network, for detection information indicating an abnormal event detected by the monitoring apparatus. The inquiry unit 12 transmits inquiry information for inquiring about a factor in the occurrence of the event included in the detection information, to a language model, and acquires response information in response to the inquiry information, from the language model. The display unit 13 displays the detection information, the environment information, and the response information.

The acquisition unit 11 further acquires history information indicating a history of anomalies detected by the monitoring apparatus, for the detection information, and displays the history information on the display unit 13.

In this manner, in an example embodiment, by presenting detection information, environment information, and response information to a user (an operator who responds to a security incident when it occurs, such as a monitoring analyst, CSIRT (Computer Security Incident Response Team), or SOC (Security Operation Center)), it is possible to assist in reducing the time required for anomaly analysis on the network.

### [System Configuration]

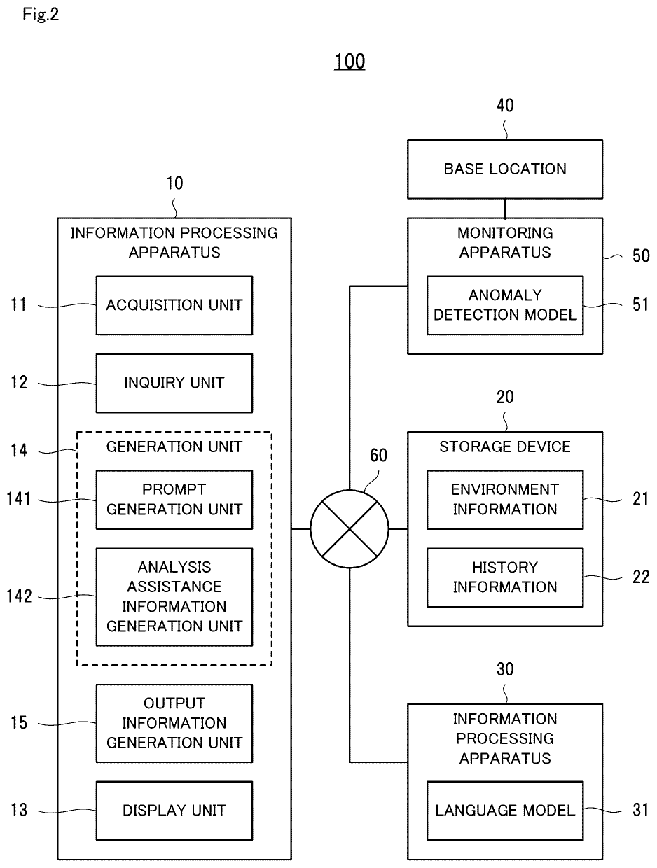

Next, the information processing apparatus 10 according to an example embodiment will be described in more detail with reference to FIG. 2. FIG. 2 is a diagram for describing an example of a system that includes an information processing apparatus.

As shown in FIG. 2, a system 100 according to an example embodiment includes the information processing apparatus 10, a storage device 20, an information processing apparatus 30, a base location 40, and a monitoring apparatus 50. In addition, in the example in FIG. 2, the information processing apparatus 10, the storage device 20, the information processing apparatus 30, the base location 40, and the monitoring apparatus 50 are communicably connected to each other via a network 60.

The information processing apparatus 10 is, for example, a CPU (Central Processing Unit), a programmable device such as an FPGA (Field-Programmable Gate Array), a GPU (Graphics Processing Unit), a circuit in which one or more thereof are mounted, a server computer, a personal computer, or a mobile terminal, which is used by the user to perform anomaly analysis.

The storage device 20 is a database, a server computer, a circuit that includes a memory, or the like. The storage device 20 stores, for example, at least environment information 21 and history information 22. In the example in FIG. 2, the storage device 20 is provided outside the information processing apparatus 10, but may be provided inside the information processing apparatus 10.

The information processing apparatus 30 is, for example, a CPU, a programmable device such as an FPGA, a GPU, a circuit in which one or more thereof are mounted, a server computer, or the like, in which a language model 31 is implemented.

The base location 40 refers to a corporate network constructed both domestically and internationally. The monitoring apparatus 50 collects communication logs from the corporate network constructed at the base location 40, and, when an anomaly detection model 51 detects an anomaly based on collected communication logs, transmits detection information to the information processing apparatus 10. The monitoring apparatus 50 is, for example, a CPU, a programmable device such as an FPGA, a GPU, a circuit in which one or more thereof are mounted, or a computer. Note that, in the example in FIG. 2, the anomaly detection model 51 is provided in the monitoring apparatus 50, but may be provided outside the monitoring apparatus 50.

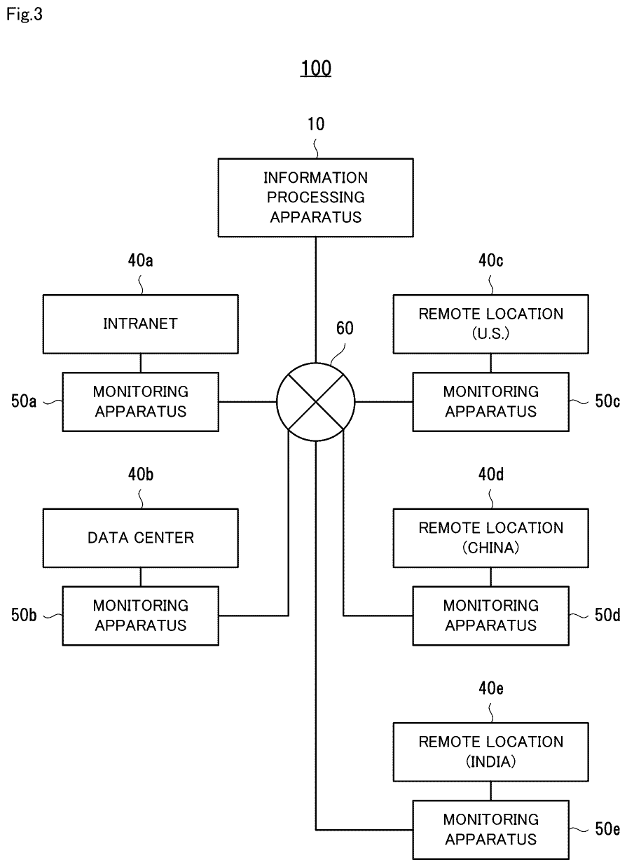

FIG. 3 is a diagram for describing an example of information processing apparatuses and a corporate network. The system 100 is a corporate network constructed both domestically and internationally, for example. The system 100 in FIG. 3 includes the information processing apparatus 10, base locations 40 (40a to 40e), and monitoring apparatuses 50 (50a to 50e). In addition, in the example in FIG. 3, the information processing apparatus 10 and the monitoring apparatuses 50 (50a to 50e) are communicably connected to each other via the network 60.

The base locations 40a to 40e are networks constructed as an intranet 40a, a data center 40b, a remote location (U.S.) 40c, a remote location (China) 40d, and a remote location (India) 40e, for example.

The monitoring apparatuses 50a to 50e respectively collect communication logs of the networks constructed at the base locations 40a to 40e, for example. The monitoring apparatus 50a in FIG. 3 collects communication logs of the intranet 40a, for example.

The network 60 is a communication network constructed using a communication line such as the Internet, a LAN (Local Area Network), a dedicated line, a phone line, a corporate network, a mobile communication network, Bluetooth (registered trademark), or Wi-Fi (Wireless Fidelity) (registered trademark).
The monitoring apparatus 50 will be described in detail.

The monitoring apparatus 50 first collects communication logs of the base location 40 of the corporate network. Next, the monitoring apparatus 50 inputs the collected communication logs to the anomaly detection model 51 for detecting a predetermined anomaly, and performs anomaly detection processing. Next, when the anomaly detection model 51 detects an anomaly, the monitoring apparatus 50 notifies the acquisition unit 11 and the inquiry unit 12 that an anomaly has been detected (transmits anomaly detection information).

The anomaly detection model aggregates specific attributes of communication logs (text logs) by time unit, converts the resultant into time-series data, and performs processing for detecting an anomaly based on the time-series data obtained through conversion. Note that a machine learning model or the like may be used as the anomaly detection model.

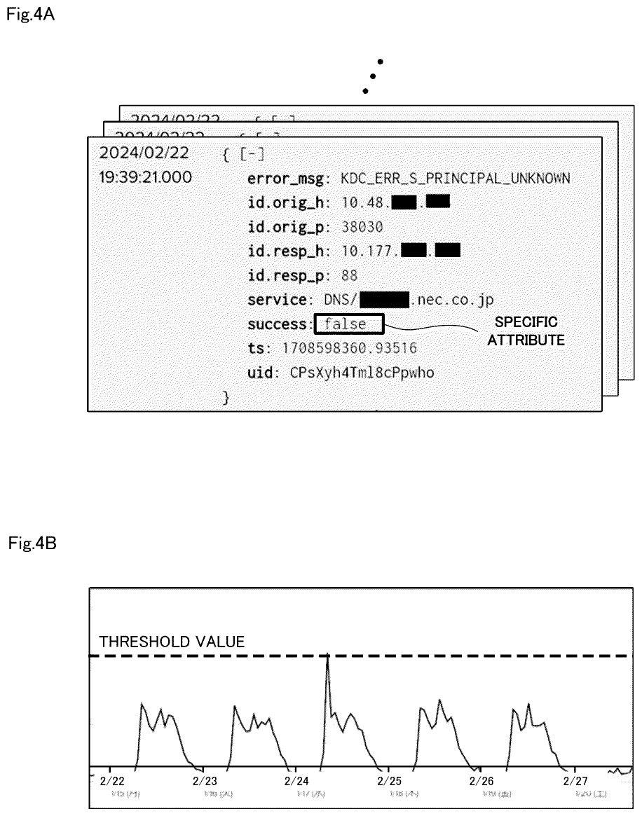

FIG. 4 is a diagram for describing an example of operations of the anomaly detection model. FIG. 4A shows an example of text logs that can be acquired through NDR (Network Detection and Responding). Note that the text logs are variable-length logs that have a plurality of attributes across a plurality of protocols. In addition, FIG. 4B shows an example of time-series data obtained by performing appropriate pre-processing on text logs. In the example in FIG. 4B, it is determined that an anomaly has occurred when a preset threshold value (broken line) is reached. The time-series data is data obtained by aggregating specific attributes of text logs by time unit, and converting the resultant into time-series data.

Examples of anomaly include an anomaly in the number of cases of true/false in Kerberos user authentication and an anomaly in the number of times of SSH (Secure Shell) connection (login) attempts. The examples of anomaly also include authentication access from an environment that is usually impossible. Such an anomaly may be unintended multiple authentication attempts during an overseas business trip, for example. Furthermore, the examples of anomaly also include an event that impairs availability. Such an anomaly may be a large number of connection attempts from multiple users due to unintended shutdown of an SSH server.

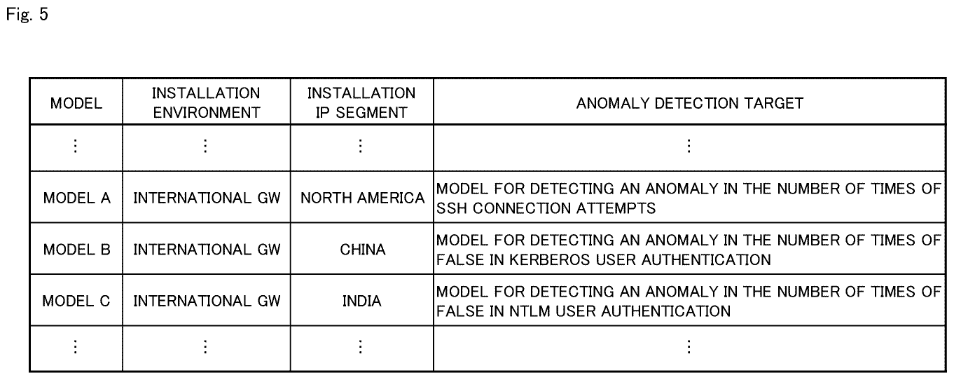

FIG. 5 is a diagram for describing an example of anomaly detection models. In the example in FIG. 5, “model” indicating anomaly detection models is associated with “installation environment”, “installation IP segment”, and “anomaly detection target”. “Model” has identification information for identifying the anomaly detection models. The example in FIG. 5 includes “model A”, “model B”, “model C”, . . . as the identification information. “Installation environment” indicates base locations that are monitored by the anomaly detection models. The example in FIG. 5 includes “international GW” as base locations. “Installation IP segment” indicates country names where the base locations that are monitored are located. The example in FIG. 5 includes “North America”, “China”, and “India”.

“Anomaly detection target” indicates the content of anomalies to be detected by the anomaly detection models. The example in FIG. 5 includes “model for detecting an anomaly in the number of times of SSH connection (specific attribute) attempts”, “model for detecting an anomaly in the number of times of false (specific attribute) in Kerberos user authentication”, and “model for detecting an anomaly in the number of times of false (specific attribute) in NTLM (New Technology LAN Manager) user authentication”. Note that there is no limitation to the above anomaly detection models.
The information processing apparatus (anomaly analysis assistance apparatus) will be described in detail.

The information processing apparatus 10 in FIG. 2 includes the acquisition unit 11, the inquiry unit 12, a generation unit 14 (a prompt generation unit 141 and an analysis assistance information generation unit 142), an output information generation unit 15, and the display unit 13.

When detection information indicating an abnormal event detected by a monitoring apparatus 50 is received, the acquisition unit 11 performs a search based on a search condition set for each of the monitoring apparatuses 50 (anomaly detection models) in advance, and acquires, from the storage device 20, the environment information 21 indicating the environment of communication of the monitoring apparatus 50 that has detected the anomaly, and the history information 22 indicating a history of anomalies detected by the monitoring apparatus 50 in the past.

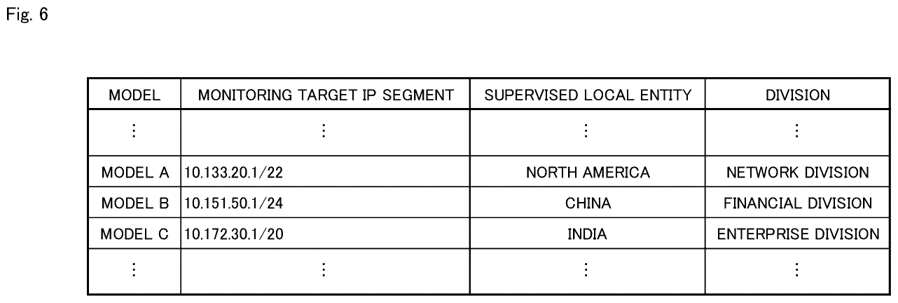

FIG. 6 is a diagram for describing an example of environment information. In the example in FIG. 6, “model” indicating anomaly detection models is associated with “monitoring target IP segment”, “supervised local entity”, and “division”. “Model” has identification information for identifying the anomaly detection models. The example in FIG. 6 includes . . . , “model A”, “model B”, “model C”, . . . , as the identification information. “Monitoring target IP segment” indicates IP segments of the monitoring apparatuses. A monitoring target IP segment refers to a network area that is monitored by “model”, and is a segment that includes, as targets, all IP addresses that are present under a corresponding subnet. The example in FIG. 6 includes “10.133.20.1/22”, “10.151.50.1/24”, “10.172.30.1/20”, . . . , as monitoring target IP segments. “Supervised local entity” indicates country names where local entities supervised by the monitoring apparatuses are located. The example in FIG. 6 includes . . . , “North America”, “China”, “India”, . . . “Division” indicates divisions supervised by the monitoring apparatuses. The example in FIG. 6 includes . . . , “network division”, “financial division”, “enterprise division”, . . . .

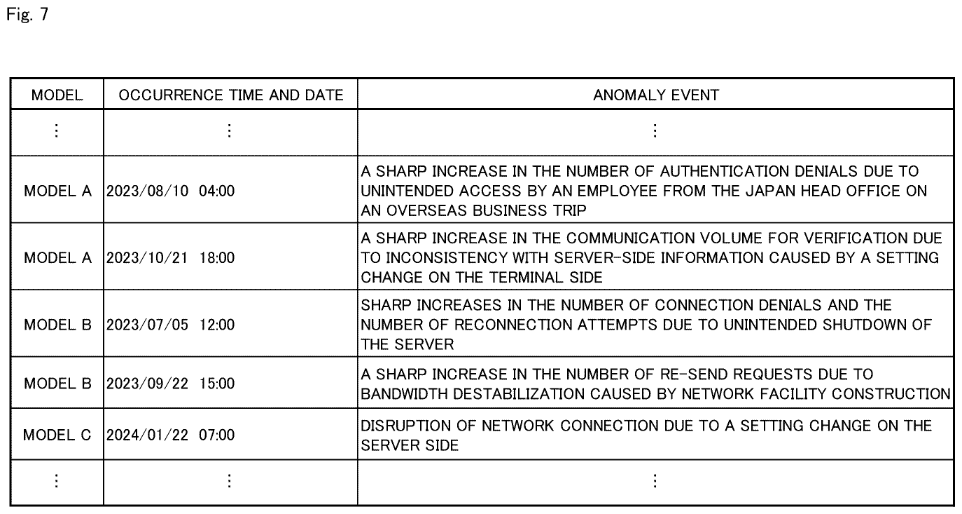

FIG. 7 is a diagram for describing an example of history information. In the example in FIG. 7, “model” indicating anomaly detection models is associated with “occurrence time and date” and “anomaly event”. “Model” indicates identification information for identifying the anomaly detection models. The example in FIG. 7 includes . . . , “model A”, “model A”, “model B”, “model B”, “model C”, . . . as identification information. “Occurrence time and date” indicates times and dates when the anomaly detection models detected anomalies. The example in FIG. 7 includes . . . , “2023/08/10 10 04:00”, “2023/10/21 18:00”, “2023/07/05 12:00”, “2023/09/22 15:00”, “2024/01/22 07:00”, . . . as occurrence times and dates.

“Anomaly event” indicates the content of events detected by the anomaly detection models in the past. The example in FIG. 7 includes “a sharp increase in the number of authentication denials due to unintended access by an employee from the Japan head office on an overseas business trip”, “a sharp increase in the communication volume for verification due to inconsistency with server-side information caused by a setting change on the terminal side”, “sharp increases in the number of connection denials and the number of reconnection attempts due to unintended shutdown of the server”, “a sharp increase in the number of re-send requests due to bandwidth destabilization caused by network facility construction”, and “disruption of network connection due to a setting change on the server side”. Note that there is no limitation to the above anomaly events.

When detection information indicating an abnormal event detected by a monitoring apparatus 50 is received, the inquiry unit 12 generates inquiry information (prompt) for inquiring about a factor in the occurrence of the event included in the detection information, based on the detected abnormal event, the inquiry information being to be input to the language model 31. The language model 31 is a Large language model (LLM) such as ChatGPT or BERT.

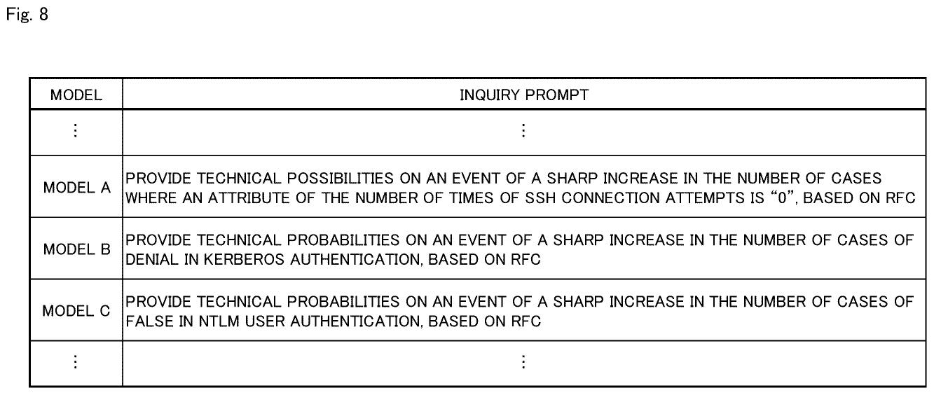

FIG. 8 is a diagram for describing an example of inquiry information. The example in FIG. 8 includes “inquiry prompt” indicating inquiry information and corresponding to “model” indicating anomaly detection models. “Model” indicates identification information for identifying the anomaly detection models. The example in FIG. 8 includes . . . , “model A”, “model B”, “model C”, . . . as identification information.

“Inquiry prompt” indicates prompts to be input to a language model. The example in FIG. 8 includes, as inquiry prompts, “Provide technical possibilities on an event of a sharp increase in the number of cases where an attribute of the number of times of SSH connection attempts is “0”, based on RFC (Request for Comment)”, “Provide technical probabilities on an event of a sharp increase in the number of cases of denial in Kerberos authentication, based on RFC”, “Provide technical probabilities on an event of a sharp increase in the number of cases of false in NTLM user authentication, based on RFC”. Note that there is no limitation to the above inquiry prompts.

Next, the inquiry unit 12 transmits the generated inquiry information to the language model 31. The inquiry unit 12 then acquires response information output by the language model 31 in response to the inquiry information.

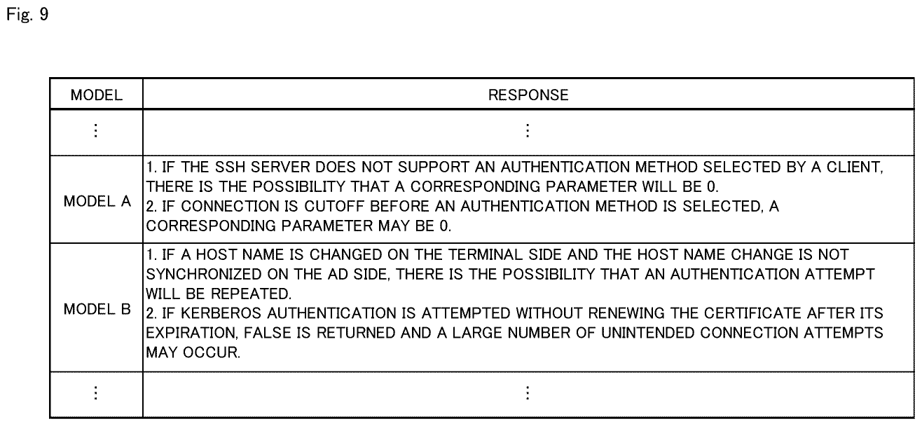

FIG. 9 is a diagram for describing an example of response information. The example in FIG. 9 shows “response” indicating response information corresponding to “model” indicating anomaly detection models. “Model” has identification information for identifying the anomaly detection models. The example in FIG. 9 includes . . . “model A”, “model B”, . . . as identification information. “Response” indicates responses from the language models in response to input prompts. The example in FIG. 9 includes, as responses, “1. If the SSH server does not support an authentication method selected by a client, there is the possibility that a corresponding parameter will be 0. 2. If connection is cutoff before an authentication method is selected, a corresponding parameter may be 0”, “1. If a host name is changed on the terminal side and the host name change is not synchronized on the AD side, there is the possibility that an authentication attempt will be repeated. 2. If Kerberos authentication is attempted without renewing the certificate after its expiration, false is returned and a large number of unintended connection attempts may occur”. Note that there is no limitation to the above responses.

The generation unit 14 generates analysis assistance information (anomaly detection alert) for assisting in anomaly analysis by a user who is monitoring and managing a corporate network, using the detection information, the environment information 21, and the response information. Alternatively, the generation unit 14 may generate analysis assistance information using the detection information, the environment information 21, the history information 22, and the response information. Alternatively, the generation unit 14 may generate analysis assistance information using the environment information 21, the history information 22, and the response information.

Specifically, the generation unit 14 includes the prompt generation unit 141 and the analysis assistance information generation unit 142. The prompt generation unit 141 generates a prompt of analysis assistance information (anomaly detection alert) using the detection information, the environment information 21, the history information 22, and the response information.

As a prompt, for example, “Generate an anomaly detection alert using detection information “anomaly detection by the model A at 4:00 on 2023/12/20”, environment information “the North America IP segment supervised by the network division”, history information “actual anomaly cases of a sharp increase in the number of unintended accesses by employees on business trips in 2023/8 and a sharp increase in the number of accesses due to a setting change on the terminal side in 2023/10”, and response information “1. If the SSH server does not support an authentication method selected by a client, there is the possibility that a corresponding parameter will be 0. 2. If connection is cutoff before an authentication method is selected, a corresponding parameter may be 0” is generated.

In addition, the analysis assistance information generation unit 142 transmits the generated prompt to the language model 31, and acquires analysis assistance information (anomaly detection alert) generated for the prompt, from the language model 31. Note that a language model different from the language model used by the inquiry unit 12 may be used.

As the analysis assistance information (anomaly detection alert), for example, “At 4:00 on 2023/12/20, an anomaly was detected by the Model A. This event occurred in the North America IP segment supervised by the network division, and actual anomaly cases that occurred in the same environment in the past are: a sharp increase in the number of unintended accesses by employees on business trips in 2023/8 and a sharp increase in the number of accesses due to a setting change on the terminal side in 2023/10. As a technical factor in this event, “1. If the SSH server does not support an authentication method selected by a client, there is the possibility that a corresponding parameter will be 0”, “2. If connection is cutoff before an authentication method is selected, a corresponding parameter may be 0”, or the like is generated.

In order to display the content of the analysis assistance information (anomaly detection alert) on the display unit 13, the output information generation unit 15 generates output information subjected to conversion into a format that can be output to the display unit 13, and outputs the generated output information to the display unit 13.

The display unit 13 acquires the output information, and outputs generated images and the like based on the information. The display unit 13 is, for example, an image display device that employs a liquid crystal display, an organic EL (Electro Luminescence) display, a CRT (Cathode Ray Tube), or the like. Note that the display unit 13 may be provided outside the information processing apparatus 10. Furthermore, the display unit 13 may also include a sound output device such as a speaker. Note that the display unit 13 may also be a print apparatus such as a printer.

### [Apparatus Operations]

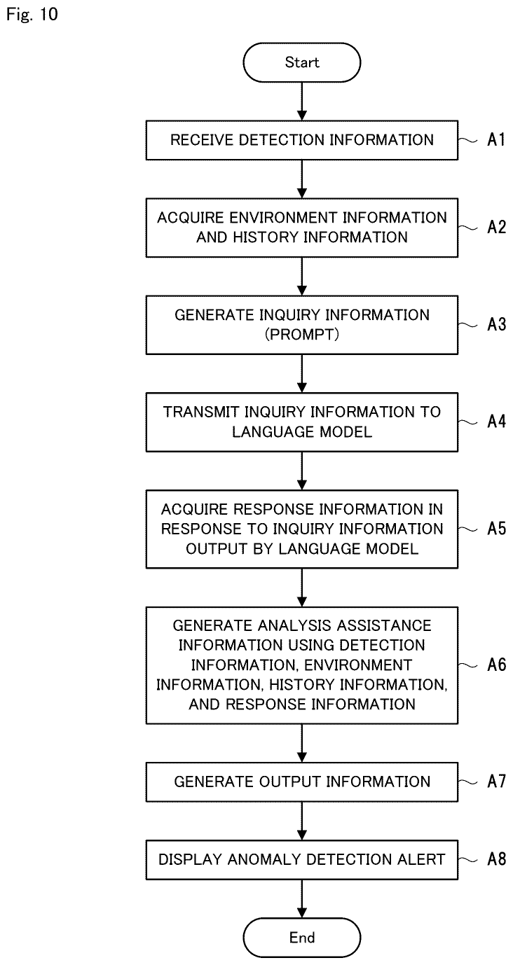

Next, operations of the information processing apparatus according to an example embodiment will be described with reference to FIG. 10. FIG. 10 is a diagram for describing an example of operations of the information processing apparatus. In the following description, figures will be referenced as appropriate. In addition, in an example embodiment, by causing the information processing apparatus to operate, an information processing method is performed. Thus, a description of the information processing method according to an example embodiment is replaced by the following description of the operations of the information processing apparatus.

As shown in FIG. 10, first, the acquisition unit 11 receives detection information indicating an abnormal event detected by a monitoring apparatus 50 (step A1). Next, when the detection information is received, the acquisition unit 11 performs a search based on a search condition set for each of the monitoring apparatuses 50 (anomaly detection models) in advance, and acquires, from the storage device 20, the environment information 21 indicating the environment of communication of the monitoring apparatus 50 that detected the anomaly, and the history information 22 indicating a history of anomalies detected by the monitoring apparatus 50 in the past (step A2).

Next, when detection information indicating an abnormal event detected by the monitoring apparatus 50 is received, the inquiry unit 12 generates inquiry information (prompt) for inquiring about a factor in the occurrence of the event included in the detection information based on the detected abnormal event, the inquiry information being to be input to the language model 31 (step A3). Next, the inquiry unit 12 transmits the generated inquiry information to the language model 31 (step A4). Next, the inquiry unit 12 acquires response information in response to the inquiry information output by the language model 31 (step A5).

Note that the processing of step A2 may be executed after or in parallel with the processing of steps A3 to A5.

Next, the generation unit 14 generates analysis assistance information for assisting in anomaly analysis by a user who is monitoring and managing the corporate network, using the detection information, the environment information 21, the history information 22, and the response information (step A6). Alternatively, the generation unit 14 may generate analysis assistance information using the detection information, the environment information 21, and the response information. Alternatively, the generation unit 14 may also generate analysis assistance information using the environment information 21, the history information 22, and the response information.

Specifically, in step A6, the prompt generation unit 141 generates a prompt of analysis assistance information (anomaly detection alert) using the detection information, the environment information 21, the history information 22, and the response information. Next, the analysis assistance information generation unit 142 transmits the generated prompt to the language model 31, and acquires analysis assistance information (anomaly detection alert) generated for the prompt, from the language model 31.

Next, in order to display the content of the analysis assistance information (anomaly detection alert) on the display unit 13, the output information generation unit 15 generates output information subjected to conversion into a format that can be output to the display unit 13 and outputs the generated output information to the display unit 13 (step A7).

Next, the display unit 13 acquires the output information, and displays generated analysis assistance information (anomaly detection alert) and the like based on the output information (step A8).

### First Example

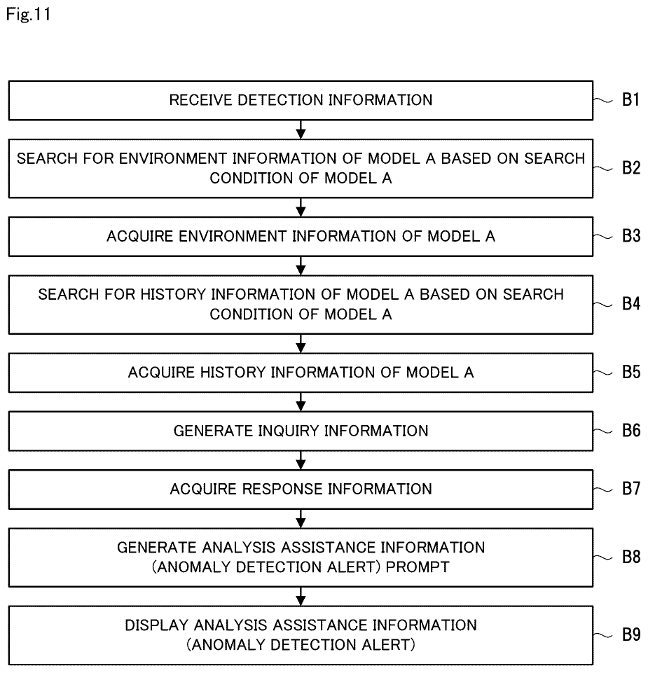

FIG. 11 is a diagram for describing a first example embodiment. In the example in FIG. 11, first, in step B1, (1) “An anomaly in the number of times of SSH authentication attempts was detected by the model A at 12:00 on 2023/12/10” is acquired as detection information.

Next, in step B2, environment information of the model A is searched for based on a search condition of the model A. Next, in step B3, (2) “The environment is a segment for Taipei that is an offshore location of the financial division” is acquired as the environment information of the model A.

Next, in step B4, history information of the model A is searched for based on a search condition of the model A. Next, in step B5, (3) “1. A power failure occurred in the SSH server that was being used for **PJ and the anomaly was detected on 2023/10/10. 2. An anomaly caused by a setting mistake in the SSH server that was being used by ΔΔ was detected on 2023 Oct. 30” is acquired as history information of the model A.

Next, in step B6, as inquiry information, “Please explain a factor in a sharp increase in the number of cases where a parameter for the number of times of SSH authentication attempts is “0”, which is an event that is being monitored by the model A” is generated. Next, in step B7, (4) “1. If the SSH server does not support an authentication method selected by a client, there is the possibility that the parameter will be 0. 2. If connection is cutoff before an authentication method is selected, the parameter may be 0” is acquired as response information.

Next, in step B8, “In the environment information (2), there is the possibility of (4) as an event, and there was an actual case of anomaly detection of (3) in the past” is generated as a prompt for generating analysis assistance information (anomaly detection alert). The prompt is then input to a language model, and analysis assistance information (anomaly detection alert) for the prompt is acquired from the language model.

Next, in step B9, analysis assistance information (anomaly detection alert) “an anomaly in the number of times of SSH authentication attempts was detected in a segment of Taipei that is an offshore location of a financial division at 12:00 on 2023/12/10. There is the possibility that this anomaly will occur when each server setting is . . . , and, in the past, in this environment, an anomaly of OO occurred in August 2023, and an anomaly of ΔΔ occurred in October” is displayed on the display unit 13.

### Second Example

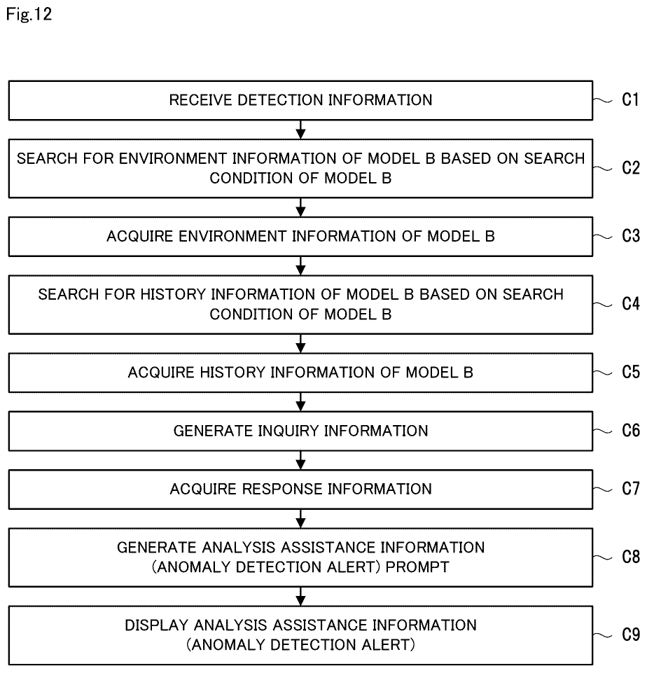

FIG. 12 is a diagram for describing a second example embodiment. In the example in FIG. 12, first, in step C1, (1) “model B” for detecting an anomaly of false in Kerberos authentication denial detected an anomaly at 4:00 on 2023/12/20” is acquired as detection information.

Next, in step C2, environment information of the model B is searched for based on a search condition of the model B. Next, in step C3, (2) “the corresponding environment is a Wi-Fi segment for employees from the U.S. branch office on an overseas business trip” is acquired as the environment information of the model B.

Next, in step C4, history information of the model B is searched for based on a search condition of the model B. Next, in step C5, (3) “1. A large number of unintended authentication attempts occurred due to a setting change on the terminal side on 2023/11/5. 2. A large number of authentication requests were made following a long holiday and the number of cases of false also increased on 2024/1/10” is acquired as the history information of the model B.

Next, in step C6, “inquiry about a factor in a sharp increases in the number of times of false in Kerberos authentication denial, which is an event that is being monitored by the model B” is generated as inquiry information. Next, in step C7, (4) “1. If, after a host name change on the terminal side, the host name change is not synchronized on the AD side, there is the possibility that an authentication attempt will be repeated. 2. If Kerberos authentication is attempted without renewing the certificate after its expiration, false is returned and a large number of unintended connection attempts may occur” is acquired as response information.

Next, in step C8, “In the environment information (2), there is the possibility of (4) as an event, and there was an actual case of anomaly detection of (3) in the past” is generated as a prompt for generating analysis assistance information (anomaly detection alert). The prompt is then input to a language model, and analysis assistance information (anomaly detection alert) for the prompt is acquired from the language model.

Next, in step C9, analysis assistance information (anomaly detection alert) “An anomaly of a massive occurrence of false in Kerberos was detected in a Wi-Fi segment for employees from the U.S. branch office on an overseas business trip at 4:00 on 2023/12/20. This anomaly may also occur due to a user's unintended setting change or the like, and, in this environment in the past, an anomaly of OO occurred in August 2023, and an anomaly of ΔΔ occurred in October.” is displayed on the display unit 13.

### Modified Example

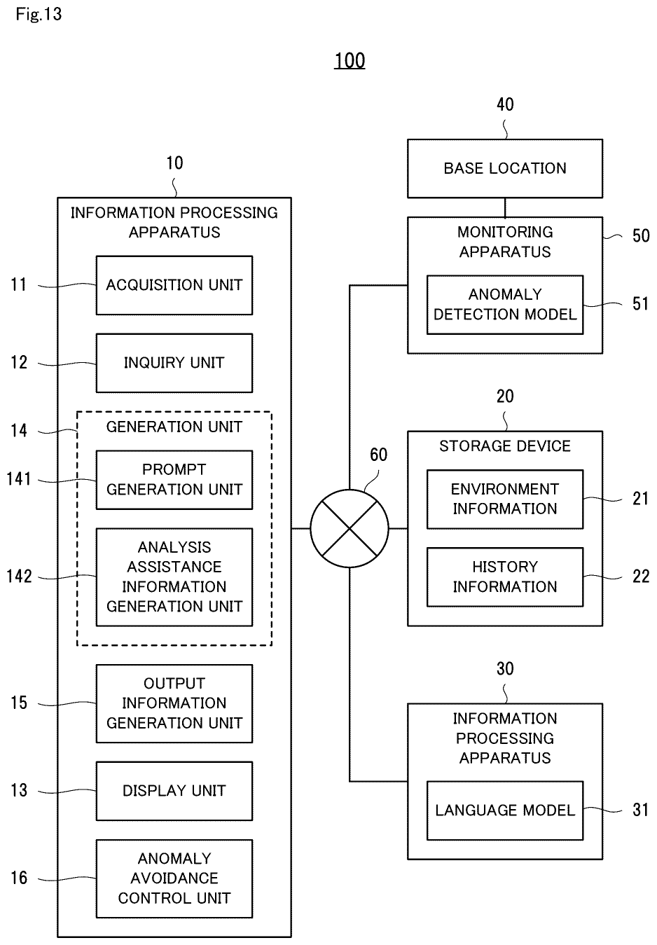

FIG. 13 is a diagram for describing an example of a modified example. As a modified example, an anomaly avoidance control unit 16 may be added to the information processing apparatus 10 in FIG. 13. The anomaly avoidance control unit 16 generates control instruction information for avoiding an anomaly based on analysis assistance information, and controls a device that is an anomaly detection target and is provided in the network 60.

As control (anomaly avoidance control) of a device that is an anomaly detection target, for example, blocking through firewalls, isolating endpoints, and the like are executed. Furthermore, as anomaly avoidance control, anomaly detection information may be stored in a database or whitelisted, compared with data using those, and the like.

### Effects of Example Embodiment

Conventionally, time-series anomaly detection data has been used to perform anomaly detection on various protocols, and, after a user (monitoring analyst and the like) conducted research on the surroundings, interviews and incident response have been conducted. That is to say, after anomaly detection, humans are performing analysis specialized in peaks of time-series data and the like. For example, at the time of anomaly analysis, an increase in the number of cases of Kerberos user authentication is detected, an environment and a terminal apparatus are then specified from an IP address, and, after that, the difference from a normal state is specified or interviews and the like are conducted such that the analysis is complemented.

For this reason, only with detection output of time series anomaly detection data, it requires a significant amount of time to perform research and collect information on environment information, technical information, actual cases in the past, and the like until an event is specified from detection information.

In addition, in many cases, information that is output only from time series anomaly detection data is limited to occurrence times and dates and protocols and errors that are anomaly detection targets, and thus lacks explainability.

However, according to the example embodiment, it is possible to reduce the time required for anomaly analysis on a network by automatically generating a verbalized anomaly detection alert, and presenting the alert to the user. That is to say, by automatically generating an anomaly detection alert by integrating technical information that has already been standardized, actual cases in the past, and internally accumulated knowledge information, it is possible to reduce the analysis time required for the user after anomaly detection. In addition, new findings can be provided to the user.

In addition, an anomaly detection alert is rich information obtained by adding environment information, history information, and response information (events conceivable from standard technical information such as RFC) to detection information, and thus can enhance the explainability.

### [Program]

The program according to the example embodiment and the modified example may be a program that causes a computer to execute steps A1 to A8 shown in FIG. 10. By installing this program in a computer and executing the program, the information processing apparatus and the information processing method according to the example embodiment can be realized. Further, the processor of the computer performs processing to function as the acquisition unit 11, the inquiry unit 12, the generation unit 14 (the prompt generation unit 141 and the analysis assistance information generation unit 142), an output information generation unit 15, and the anomaly avoidance control unit 16.

Also, the program according to the example embodiment and the modified example may be executed by a computer system constructed by a plurality of computers. In this case, for example, each computer may function as any of the acquisition unit 11, the inquiry unit 12, the generation unit 14 (the prompt generation unit 141 and the analysis assistance information generation unit 142), an output information generation unit 15, and the anomaly avoidance control unit 16.

### [Physical Configuration]

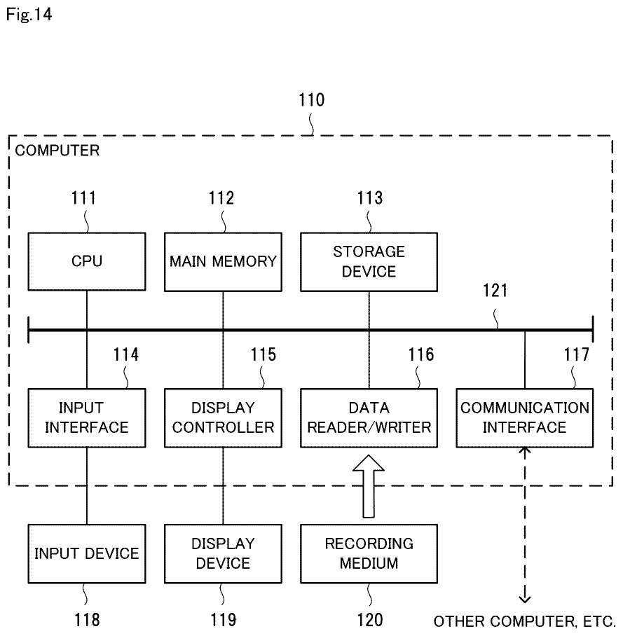

Here, a computer that realizes an information processing apparatus by executing the program according to the example embodiment will be described with reference to FIG. 14. FIG. 14 is a diagram for describing an example of a computer that realizes the information processing apparatus in the example embodiment and the modified example.

As shown in FIG. 14, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU 111 or instead of the CPU 111.

The CPU 111 loads a program (codes) according to the example embodiments stored in the storage device 113 to the main memory 112, and executes them in a predetermined order to perform various kinds of calculations. The main memory 112 is typically a volatile storage device such as a DRAM (Dynamic Random Access Memory).

Also, the program according to the example embodiments are provided in the state of being stored in a computer-readable recording medium 120. Note that the program according to the first and second example embodiments and the first and second working examples may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus 10 according to the example embodiment can also be achieved using hardware corresponding to the components, instead of a computer in which a program is installed. Furthermore, a part of the information processing apparatus 10 may be realized by a program and the remaining part may be realized by hardware. In the example embodiments, the computer is not limited to the computer shown in FIG. 14.

### Supplementary Notes

Furthermore, the following supplementary notes are disclosed regarding the example embodiment described above. Some portion or all of the example embodiments described above can be realized according to (supplementary note 1) to (supplementary note 15) described below, but the below description does not limit the present invention.

### Supplementary Note 1

An information processing apparatus comprising:
an acquisition unit for acquiring environment information indicating an environment of communication that is monitored by a monitoring apparatus that monitors communication in a network, for detection information indicating an abnormal event detected by the monitoring apparatus;
an inquiry unit for transmitting inquiry information for inquiring about a factor in the occurrence of the event included in the detection information, to a language model, and acquire response information in response to the inquiry information, from the language model; and
a display unit for displaying the detection information, the environment information, and the response information.

### Supplementary Note 2

The information processing apparatus according to Supplementary Note 1,
wherein the acquisition unit further acquires history information indicating a history of anomalies detected by the monitoring apparatus, for the detection information, and
the display unit displays information that includes the history information.

### Supplementary Note 3

The information processing apparatus according to Supplementary Note 2, further comprising:
a prompt generation unit for generating a prompt for generating analysis assistance information for assisting in anomaly analysis, using the detection information, the environment information, the history information, and the response information; and
an analysis assistance information generation unit for transmitting the prompt to the language model, and acquire the analysis assistance information for the prompt, from the language model.

### Supplementary Note 4

The information processing apparatus according to Supplementary Note 3, further comprising
an anomaly avoidance control unit configured to generate control instruction information for avoiding the anomaly based on the analysis assistance information, and control a device that is an anomaly detection target and is provided in the network.

### Supplementary Note 5

The information processing apparatus according to any one of Supplementary Notes 1 to 4,
wherein anomaly detection set for each of a plurality of monitoring apparatuses in advance is executed, the monitoring apparatuses being provided at a plurality of locations in the network.

### Supplementary Note 6

An information processing method comprising:
acquiring, by an information processing apparatus, environment information indicating an environment of communication that is monitored by a monitoring apparatus that monitors communication in a network, for detection information indicating an abnormal event detected by the monitoring apparatus;
transmitting, by the information processing apparatus, inquiry information for inquiring about a factor in the occurrence of the event included in the detection information, to a language model;
acquiring, by the information processing apparatus, response information in response to the inquiry information, from the language model; and
displaying, by the information processing apparatus, the detection information, the environment information, and the response information, on a display unit.

### Supplementary Note 7

The information processing method according to Supplementary Note 6, further comprising:
acquiring, by the information processing apparatus, history information indicating a history of anomalies detected by the monitoring apparatus, for the detection information; and
displaying, by the information processing apparatus, information that includes the history information on a display unit.

### Supplementary Note 8

The information processing method according to Supplementary Note 7, further comprising:
generating, by the information processing apparatus, a prompt for generating analysis assistance information for assisting in anomaly analysis, using the detection information, the environment information, the history information, and the response information; and
transmitting, by the information processing apparatus, the prompt to the language model, and acquiring the analysis assistance information for the prompt, from the language model.

### Supplementary Note 9

The information processing method according to Supplementary Note 8, further comprising
generating, by the information processing apparatus, control instruction information for avoiding the anomaly based on the analysis assistance information, and controlling a device that is an anomaly detection target and is provided in the network.

### Supplementary Note 10

The information processing method according to any one of Supplementary Notes 6 to 9, further comprising
executing, by the information processing apparatus, anomaly detection set for each of a plurality of monitoring apparatuses in advance, the monitoring apparatuses being provided at a plurality of locations in the network.

### Supplementary Note 11

A computer-readable recording medium on which a program is recorded, the program for causing a computer to carry out processing for:
acquiring environment information indicating an environment of communication that is monitored by a monitoring apparatus that monitors communication in a network, for detection information indicating an abnormal event detected by the monitoring apparatus;
transmitting inquiry information for inquiring about a factor in the occurrence of the event included in the detection information, to a language model;
acquiring response information in response to the inquiry information, from the language model; and
displaying the detection information, the environment information, and the response information, on a display unit.

### Supplementary Note 12

The computer-readable recording medium according to claim 8, causing the computer to further execute processing for:
acquiring history information indicating a history of anomalies detected by the monitoring apparatus, for the detection information; and
displaying information that includes the history information on a display unit.

### Supplementary Note 13

The computer-readable recording medium according to Supplementary Note 12 for causing the computer to further execute processing for:
generating a prompt for generating analysis assistance information for assisting in anomaly analysis using the detection information, the environment information, the history information, and the response information; and
transmitting the prompt to the language model, and acquiring the analysis assistance information for the prompt, from the language model.

### Supplementary Note 14

The computer-readable recording medium according to Supplementary Note 13 for further causing the computer to execute processing for:
generating control instruction information for avoiding the anomaly based on the analysis assistance information, and controlling a device that is an anomaly detection target and is provided in the network.

### Supplementary Note 15

The computer-readable recording medium according to any one of Supplementary Notes 11 to 14 for causing the computer to execute processing for:
executing anomaly detection set for each of a plurality of monitoring apparatuses in advance, the monitoring apparatuses being provided at a plurality of locations in the network.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

According to the above description, it is possible to assist in reducing a time required for anomaly analysis on a network. In addition, the present invention is useful in a field in which anomaly analysis on a network is required.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus comprising:
at least one memory storing instructions; and
at least one processor configured to execute the instructions to:
acquire environment information indicating an environment of communication that is monitored by a monitoring apparatus that monitors communication in a network, for detection information indicating an abnormal event detected by the monitoring apparatus;
transmit inquiry information for inquiring about a factor in the occurrence of the event included in the detection information, to a language model, and acquire response information in response to the inquiry information, from the language model; and
display the detection information, the environment information, and the response information.

2. The information processing apparatus according to claim 1, wherein
the one or more processors is further configured to execute the instructions to:
acquires history information indicating a history of anomalies detected by the monitoring apparatus, for the detection information, and
displays information that includes the history information.

3. The information processing apparatus according to claim 2, further comprising:
the one or more processors is further configured to execute the instructions to:
generates a prompt for generating analysis assistance information for assisting in anomaly analysis, using the detection information, the environment information, the history information, and the response information; and
transmits the prompt to the language model, and acquiring the analysis assistance information for the prompt, from the language model.

4. The information processing apparatus according to claim 3, further comprising
the one or more processors is further configured to execute the instructions to:
generates control instruction information for avoiding the anomaly based on the analysis assistance information, and control a device that is an anomaly detection target and is provided in the network.

5. The information processing apparatus according to claim 1,
wherein anomaly detection set for each of a plurality of monitoring apparatuses in advance is executed, the monitoring apparatuses being provided at a plurality of locations in the network.

6. An information processing method comprising:
acquiring, by an information processing apparatus, environment information indicating an environment of communication that is monitored by a monitoring apparatus that monitors communication in a network, for detection information indicating an abnormal event detected by the monitoring apparatus;
transmitting, by the information processing apparatus, inquiry information for inquiring about a factor in the occurrence of the event included in the detection information, to a language model;
acquiring, by the information processing apparatus, response information in response to the inquiry information, from the language model; and
displaying, by the information processing apparatus, the detection information, the environment information, and the response information, on a display unit.

7. The information processing method according to claim 6, further comprising:
acquiring, by the information processing apparatus, history information indicating a history of anomalies detected by the monitoring apparatus, for the detection information; and
displaying, by the information processing apparatus, information that includes the history information on a display unit.

8. A non-transitory computer-readable recording medium on which a program is recorded, the program for causing a computer to carry out processing for:
acquiring environment information indicating an environment of communication that is monitored by a monitoring apparatus that monitors communication in a network, for detection information indicating an abnormal event detected by the monitoring apparatus;
transmitting inquiry information for inquiring about a factor in the occurrence of the event included in the detection information, to a language model;
acquiring response information in response to the inquiry information, from the language model; and
displaying the detection information, the environment information, and the response information, on a display unit.

9. The non-transitory computer-readable recording medium according to claim 8, causing the computer to further execute processing for:
acquiring history information indicating a history of anomalies detected by the monitoring apparatus, for the detection information; and
displaying information that includes the history information on a display unit.
